(19) United States
(12) Patent Application Publication
(10) Pub. No.: US 2006/0069834 A1
(43) Pub. Date: Mar. 30, 2006

(54) Method for supplying AGP card on PCI bus slot

(75) Inventors: Hsiao-Wen Hao, Taipei (TW); An-Sheng Chang, Taipei Hsien (TW)

Correspondence Address: TROXELL LAW OFFICE PLLC, SUITE 1404, 5205 LEESBURG PIKE, FALLS CHURCH, VA, 22041, US

(73) Assignee: GIGA-BYTE TECHNOLOGY CO., LTD.

(21) Appl. No.: 10/950,536

(22) Filed: Sep. 28, 2004

(51) Int. Cl. G06F 13/00

(52) U.S. Cl. 710/301

(57) ABSTRACT

The present invention provides a method for supplying an AGP card on a PCI bus slot and the method includes: transmitting a detecting signal to a motherboard; scanning status of a plurality of PCI bus slots on the motherboard; and out-connecting an AGP card for displaying.

### BACKGROUND OF THE INVENTION

1. Field of the Invention

The present invention is related to a method for supplying an AGP (Accelerated Graphics Port) card on a PCI (Peripheral Component Interconnect) bus slot, especially to a layout of the PCI bus arranged to a layout with an AGP bus.

2. Description of Related Art

Buses in prior art industry computers are classified into ISA (Industry Standard Architecture), VISA (Virtual Instrument Software Architecture), PCI, AGP, and so on. Moreover, a plurality of slots is set on a motherboard and interface cards are plugged into corresponding slots. The interface cards are connecting devices between the peripheral apparatuses, and the peripheral apparatuses are controlled by the motherboard through the interface cards. Further, ISA slots in early days were developed to VISA slots, and the VISA slots are then developed to PCI slots. Now, the PCI slots are further developed to AGP slots.

Nowadays, technologies are greatly improved, but still some ISA slots and PCI slots are set together on old motherboards. Therefore, when ISA slots are all plugged with ISA interface cards, another ISA interface card is impossible to be plugged into any slot on the mother board, and it is the same case with the PCI slots. An interface card with two kinds of interfaces and it can be plugged to any PCI or ISA slots on the motherboard. The slot interfaces are not restricted to specific cards and therefore, the cost is lowered.

Please refer to FIG. 1, a plurality of part components 11 is set on the interface card 10; further, a first and a second connecting interfaces 12, 13 are set on the different side of the interface card 10 and compatible to peripheral controller interface (PCI) and industry standard architecture (ISA). Besides, the first and second connecting interfaces 12, 13 are connected to the part components 11 by different wires; further, a socket 14 is set on a fringe part of the interface card 10 to be connected with the first and second connecting interface 12, 13. Furthermore, a fixed plate 15 is locked on the fringe part of the interface card 10 and it provides an opening for putting and covering the socket 14 (not shown).

However, an AGP interface card can not be plugged into a motherboard with all PCI slots, because of no AGP slot is on the motherboard. Therefore, a new motherboard with AGP slots is needed.

### SUMMARY OF THE INVENTION

The present invention provides a method for supplying an AGP card on a PCI bus slot and resolves drawbacks of prior art motherboards.

The method of the present invention provides: transmitting a detecting signal to a motherboard, scanning status of a plurality of PCI bus slots on the motherboard, and out-connecting an AGP card for displaying.

To provide a further understanding of the invention, the following detailed description illustrates embodiments and examples of the invention, this detailed description being provided only for illustration of the invention.

### BRIEF DESCRIPTION OF THE DRAWINGS

FIG. 1 shows a schematic diagram of a prior art interface card with PCI and ISA interfaces;

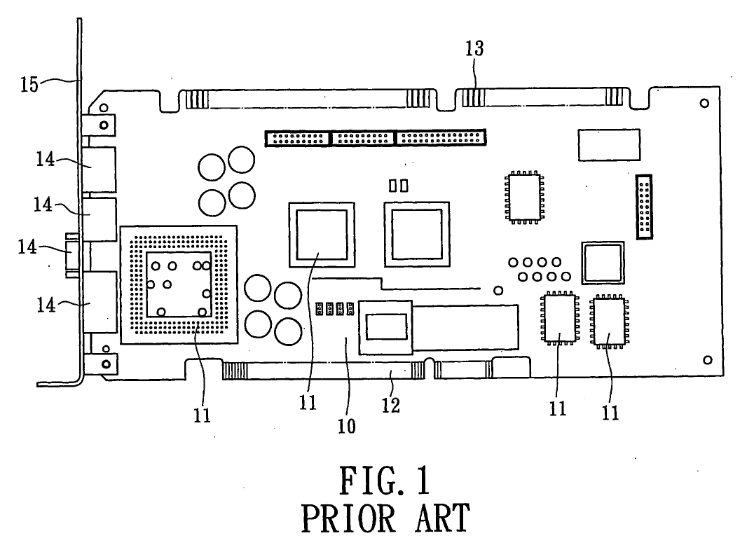

FIG. 2 shows a flow diagram of a method for supplying an AGP card on a PCI bus slot

### DETAILED DESCRIPTION OF PREFERRED EMBODIMENTS

Generally, displaying functions are provided by three different ways. First, the AGP displaying functions are provided by chips on the motherboard with built-in displaying functions and built-in displaying functions are usually utilized by portable computers for official purposes. Second, an AGP card is needed for playing computer games with fine and smooth displaying, and the AGP card is plugged into an AGP slot. Moreover, built-in displaying functions of the chips are insufficient for playing computer games. Third, the present invention provides a method for setting an AGP card on a PCI bus slot. Therefore, users can choose displaying functions provided by an out-connected AGP card or by built-in displaying functions when an AGP is not provided.

A motherboard with lower price has only PCI slots and chips with built-in displaying functions. Hence, an AGP card can be plugged into a PCI slot by putting PCI signals on AGP signals. The defined bandwidth of PCI signals is narrower than AGP signals, but pins for receiving AGP and PCI signals are the same. Moreover, AGP has better performance than the PCI and pins on the slot of AGP and PCI bus are not the same.

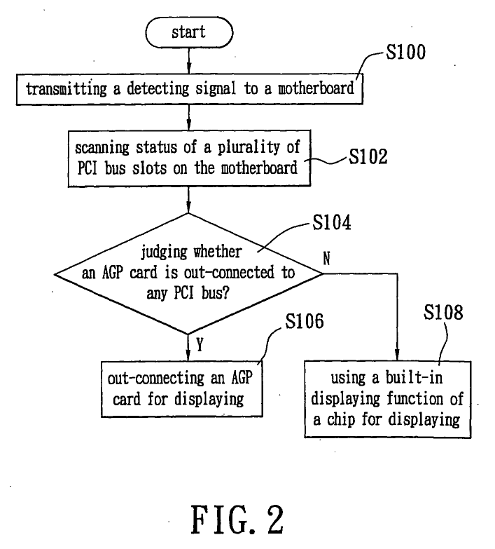

FIG. 2 shows a flow diagram for supplying a AGP card on a PCI bus slot, and it provides the following steps: transmitting a detecting signal to a motherboard (S100); scanning status of a plurality of PCI bus slots on the motherboard (S102); judging whether an AGP card is out-connected to any PCI bus (S104), and arranging a layout of the PCI bus to a layout with an AGP bus; if the result produced by (S104) is yes, then out-connecting an AGP card for displaying (S106); otherwise, using a built-in displaying chip for displaying (S108).

Prior art motherboard uses different interface cards for different functions, but present invention arranges a layout with PCI slots to a layout with an AGP slot. Therefore, signals of PCI bus is transformed to signals of AGP bus and then the AGP card can be plugged on the PCI slot of the motherboard.

There has thus been described a new, novel and heretofore unobvious PCI bus which eliminates the aforesaid problem in the prior art. Furthermore, those skilled in the art will readily appreciate that the above description is only illustrative of specific embodiments and examples of the invention. The invention should therefore cover various modifications and variations made to the herein-described structure and operations of the invention, provided the fall within the scope of the invention as defined in the following appended claims.

What is claimed is:

1. A method for supplying an AGP (Accelerated Graphics Port) card on a PCI (Peripheral Component Interconnect) bus slot, providing:
transmitting a detecting signal to a motherboard;
scanning status of a plurality of PCI bus slots on the motherboard; and
out-connecting an AGP card for displaying.

2. The method for supplying an AGP card on a PCI bus slot as in claim 1, wherein the detecting signal is provided by a basic input/output system (BIOS).

3. The method for supplying an AGP card on a PCI bus slot as in claim 1, wherein the step of scanning status of a plurality of PCI bus slots on the motherboard further includes judging whether an AGP card is out-connected to any PCI bus.

4. The method for supplying an AGP card on a PCI bus slot as in claim 3, wherein a layout of the PCI bus is arranged to a layout with an AGP bus.

5. The method for supplying an AGP card on a PCI bus slot as in claim 3, wherein if the result of judging whether an AGP card is out-connected to any PCI bus is yes, the out-connected AGP card is used for displaying; otherwise, a built-in displaying function of the chip is used for displaying.
